(19) United States
(12) Patent Application Publication
(10) Pub. No.: US 2022/0155081 A1
(43) Pub. Date: May 19, 2022

(54) APPARATUS AND METHOD FOR DETERMINING ERROR OF PRECISE MAP

(71) Applicants: HYUNDAI MOTOR COMPANY, Seoul (KR); Kia Corporation, Seoul (KR)

(72) Inventor: Seung Jai AHN, Seoul (KR)

(73) Assignees: HYUNDAI MOTOR COMPANY, Seoul (KR); Kia Corporation, Seoul (KR)

(21) Appl. No.: 17/499,119

(22) Filed: Oct. 12, 2021

(30) Foreign Application Priority Data
Nov. 18, 2020 (KR) 10-2020-0154947

(51) Int. Cl. G01C 21/34; B60W 60/00; G01C 21/00

(52) U.S. Cl. CPC G01C 21/3415; B60W 60/0011; B60W 2420/52; G01C 21/3889; G01C 21/3874

(57) ABSTRACT

The present invention relates to an apparatus and method for determining an error of a precise map that allows autonomous driving to be maintained reliably, by correcting driving control information for autonomous driving when an error is in a driving route for autonomous driving, as well as determining whether the map has an error, based on the obtained reference information to be corrected, after reference information for comparison with the map for guiding an autonomous driving route is obtained by an LiDAR sensor or a V2X module in autonomous driving.

### CROSS-REFERENCE TO RELATED APPLICATION

The present application claims priority to Korean Patent Application No 10-2020-0154947, filed on Nov. 18, 2020, the entire contents of which is incorporated herein for all purposes by this reference.

### BACKGROUND OF THE INVENTION

### Field of the Invention

The present invention relates to an apparatus and method for determining an error of a precise map that allows an autonomous vehicle to determine whether there is an error in the precise map.

### Description of Related art

In general, an autonomous vehicle continuously determines whether a road, on which the autonomous vehicle is driving, matches a driving route, based on surrounding information obtained in driving, and thus has a high dependence on a precise map based on setting a driving route.

Accordingly, when an error is present in the precise map, it may cause fatal errors in autonomous driving, which may lead to serious accidents. Therefore, the reliability of the precise map is also strictly required compared to other data.

In other words, when a traffic light or crosswalk, which is not present on the precise map, is present on an actual road, the autonomous vehicle maintains a constant speed driving state because there is no factor of deceleration or stop in an autonomous vehicle driving on the actual road. Therefore, pedestrians crossing the actual road may be dangerous.

Also, on the other hand, the precise map shows that a speed bump is present. However, when there is no speed bump on the actual road, a vehicle is unnecessarily decelerated while passing the corresponding area, and thus it may impede traffic flow.

Accordingly, the precise map is an important basis when a vehicle performs autonomous driving. Accordingly, the vehicle in autonomous driving requires a means that improves the reliability of the precise map by directly determining and verifying whether the precise map which is the basis of current driving has an error.

Also, after a safe driving route is corrected and generated in real time based on the precise map corrected by sensing data on the actual road, which is directly recognized by a vehicle through the LiDAR sensor, the vehicle may be driven autonomously. Accordingly, there is still a request for a means capable of controlling autonomous driving to be safe and not disrupt a traffic flow.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus and method for determining an error of a precise map that allows autonomous driving to be maintained reliably, by correcting driving control information for autonomous driving when an error is in a driving route for autonomous driving as well as determining whether the map has an error, based on the obtained reference information to be corrected, after reference information for comparison with the map for guiding an autonomous driving route is obtained by an LiDAR sensor or a V2X module in autonomous driving.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, an apparatus of determining an error of a precise map includes a reference information obtaining module that obtains reference information for comparison with a map, which guides a route of autonomous driving, in real time during autonomous driving, an error determining module that determines whether there is an error on the map, by comparing data on the map with the reference information, and a map error correcting module that determines whether to correct the data on the map, based on the reference information to be corrected.

Furthermore, the reference information obtaining module includes a sensor data receiver that obtains object sensing data for a surrounding object for comparison with the data on the map by a Light Detection and Ranging (LiDAR) sensor provided in a vehicle being autonomously driven, as the reference information.

Moreover, the reference information obtaining module further includes a V2X data receiver that obtains comparison map data received from one or more other vehicles by a V2X module for data communication with a surrounding vehicle, as the reference information.

Also, the error determining module includes a sensing data comparator that determines whether the reference information matches data for a corresponding object on the map, by comparing the reference information with the data for the corresponding object on the map and recognizes that there is an error in the map, when the reference information does not match the data for the corresponding object on the map.

Besides, the sensing data comparator compares traffic light information, road surface information, and line information, which are included in the object sensing data obtained from the sensor data receiver, with traffic light information, road surface information, and line information included in the map, respectively, and determines whether an error is present in at least one data about whether each object is present, a location of each object, a type of each object, or a shape of each object in the map.

Furthermore, the error determining module further includes a V2X data comparator that determines whether the comparison map data matches the data on the map, by comparing the comparison map data received from another vehicle by the V2X data receiver with the data on the map and recognizes that an error is present in the data on the map, when the comparison map data does not match the data on the map.

Furthermore, the error determining module further includes a comparison target specifying device that determines whether there is an error in the map, by determining only an area overlapping a driving route of the vehicle being autonomously driven as a comparison target, when a total amount of the data on the map to be compared and the comparison map data received from the V2X data receiver exceeds an amount of a predetermined reference configured for being processed in real time.

Moreover, the apparatus of determining an error of a precise map further include a driving route control module that corrects driving control information for the autonomous driving when a result of the determination in the error determining module indicates that there is the error in the map, and a corresponding error portion is on a driving route of the vehicle for the autonomous driving.

Also, the driving route control module is configured to change driving control information of the vehicle including whether the vehicle driving in an error area is accelerated or decelerated and whether a lane is changed, depending on content, in which an error is corrected, when the error area on the map is on a driving route of the vehicle.

Besides, the driving route control module generates a detour route configured for reaching a destination by avoiding the error area at a current location, corrects the generated detour route to a new driving route, and continues autonomous driving, when it is determined that it is difficult for the vehicle to continue driving on a current driving route due to an error existing on the map.

Furthermore, the driving route control module is configured to stop the vehicle suddenly and allows control of the vehicle to be transferred to a driver, when it is determined that an error area on the map overlaps with a current driving route of the vehicle, and that it is not possible to generate a detour route configured for reaching the destination.

According to various aspects of the present invention, a method for determining an error of a precise map includes obtaining reference information for comparison with the map, which guides a route of autonomous driving, in real time during autonomous driving, determining whether there is the error on the map, by comparing data on the map with the reference information, and determining whether to correct the data on the map according to the reference information to be corrected.

Furthermore, the obtaining of the reference information includes obtaining object sensing data associated with existence, a location, and an appearance of a surrounding object recognized by a Light Detection and Ranging (LiDAR) sensor provided in a vehicle, as the reference information for comparison with the data on the map.

Moreover, the obtaining of the reference information includes obtaining comparison map data received from surrounding other vehicles by a V2X module for data communication with a surrounding vehicle, as the reference information.

Also, the method for determining an error of a precise map further includes correcting driving control information for the autonomous driving when a result of the determination in the determining of whether there is the error on the map indicates that there is the error in the map, and a corresponding error portion is on a driving route of the vehicle for the autonomous driving.

Furthermore, the correcting of the driving control information includes changing driving control information of the vehicle including whether the vehicle autonomously driving in an error area is accelerated or decelerated and whether a lane is changed, depending on content, in which an error is corrected, when the error area on the map is on a driving route of the vehicle.

Besides, the correcting of the driving control information includes generating a detour route configured for reaching a destination by avoiding the error area at a current location, correcting the generated detour route to a new driving route, and controlling autonomous driving to be maintained, when it is determined that it is difficult for the vehicle to continue driving on a current driving route due to an error existing on the map.

Furthermore, the correcting of the driving control information includes stopping the vehicle suddenly and allowing control of the vehicle to be transferred to a driver, when it is determined that it is not possible to generate a detour route configured for reaching a destination although an error area on the map overlaps with a current driving route of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an apparatus of determining an error of a precise map, according to various exemplary embodiments of the present invention;

FIG. 2 and FIG. 3 are exemplary views exemplarily illustrating that a driving route control module corrects driving control information due to an error in a precise map, according to various exemplary embodiments of the present invention;

FIG. 4 is an exemplary view exemplarily illustrating that a driving route is maintained by a driving route control module even when an error is present in a precise map, according to various exemplary embodiments of the present invention;

FIG. 5 is an exemplary view exemplarily illustrating that a detour route is generated by a driving route control module because an error is present in the precise map, according to various exemplary embodiments of the present invention;

FIG. 6 is an exemplary diagram illustrating an example of comparing V2X information in an error determining module, according to various exemplary embodiments of the present invention;

FIG. 7 is a schematic diagram of a method for determining an error of a precise map, according to various exemplary embodiments of the present invention; and

FIG. 8 is a flowchart illustrating a flow of verifying an error of a precise map and determining whether a driving route is bypassed, according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the accompanying drawings. In adding reference numerals to components of each drawing, it should be noted that the same components have the same reference numerals, although they are indicated on another drawing. In describing the exemplary embodiments of the present invention, detailed descriptions associated with well-known functions or configurations will be omitted when they may make subject matters of the present invention unnecessarily obscure.

In describing elements of exemplary embodiments of the present invention, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which various exemplary embodiments of the present invention belongs. It will be understood that terms used herein should be interpreted as having a meaning which is consistent with their meaning in the context of the present invention and the relevant art and will not be interpreted in an idealized or overly formal sense unless expressly so defined herein.

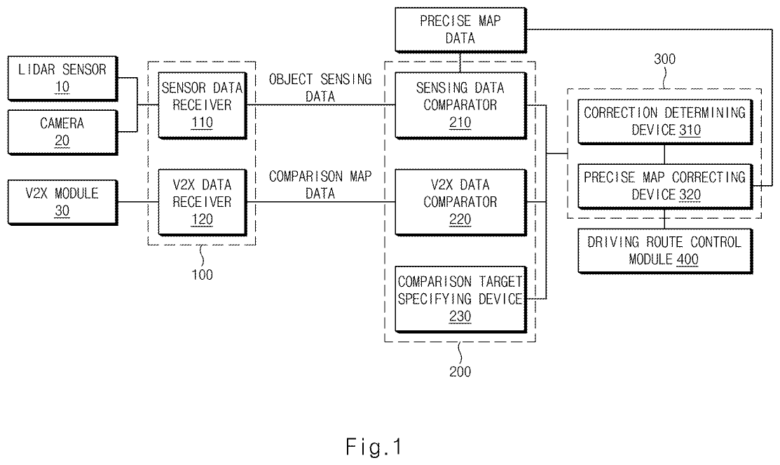

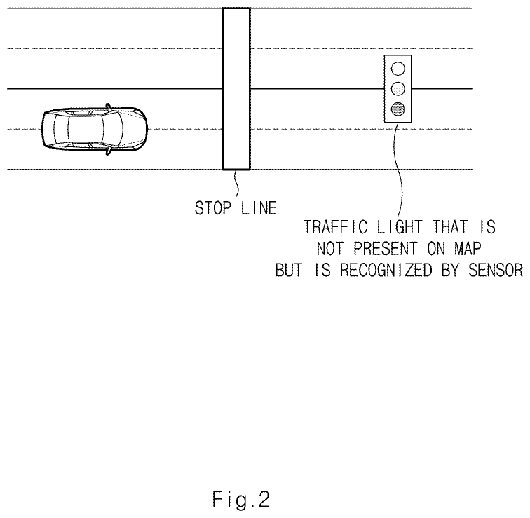

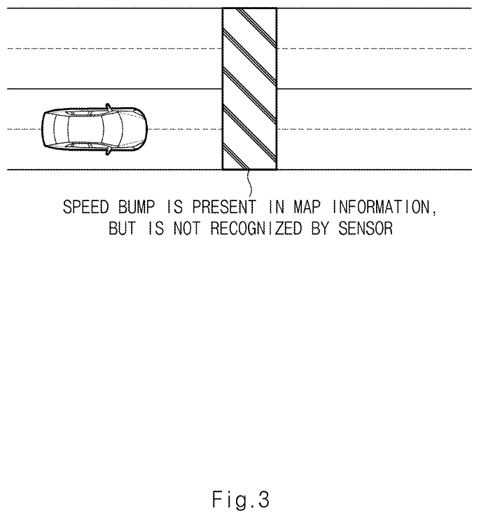

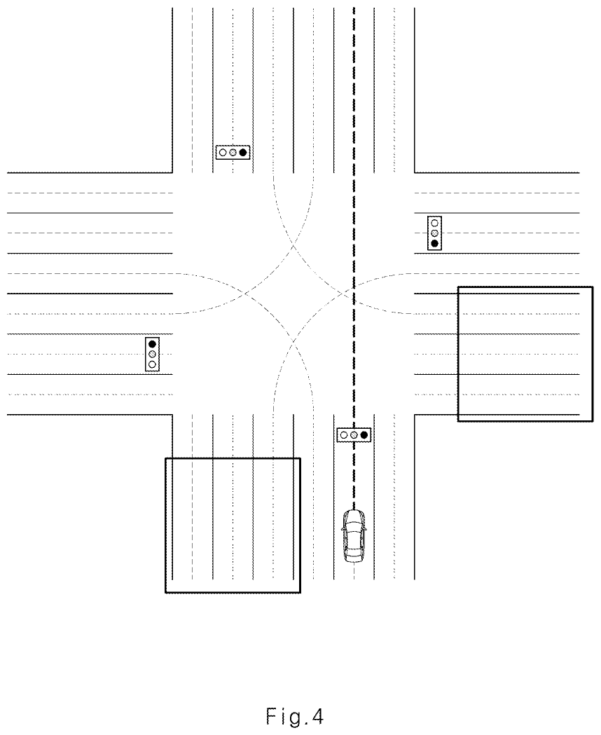

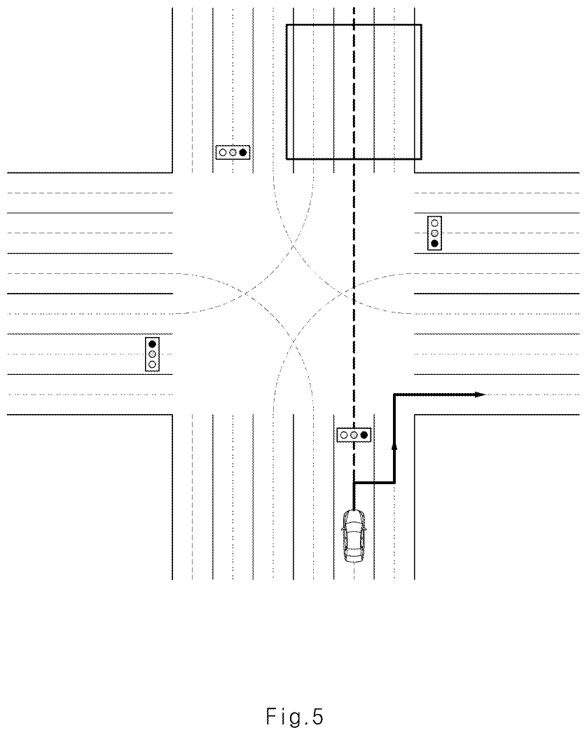

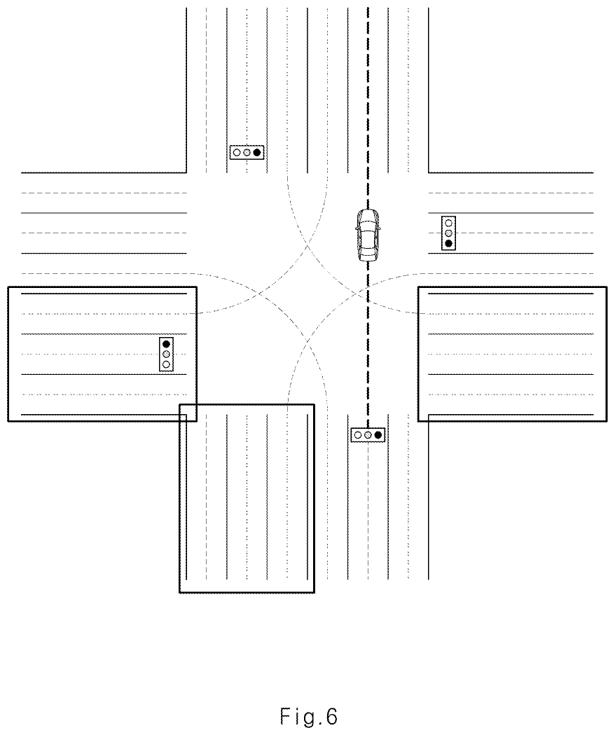

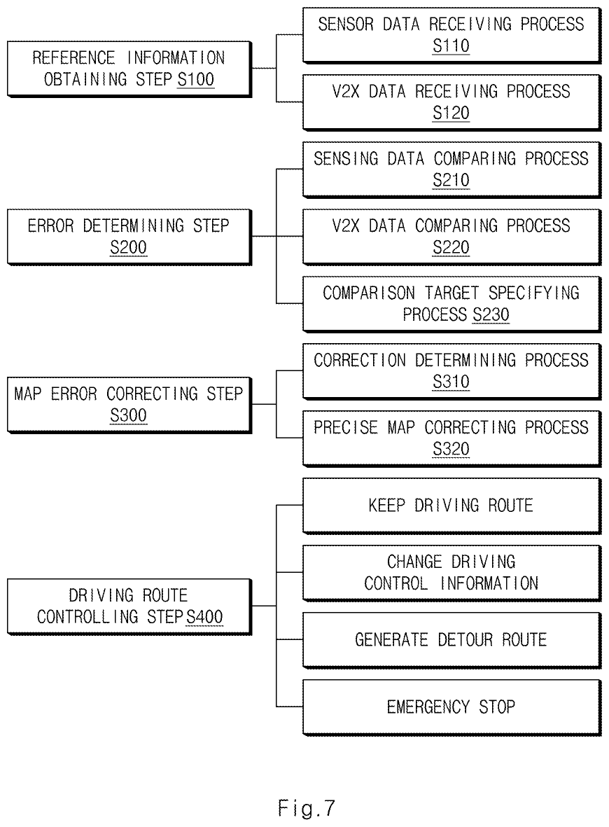

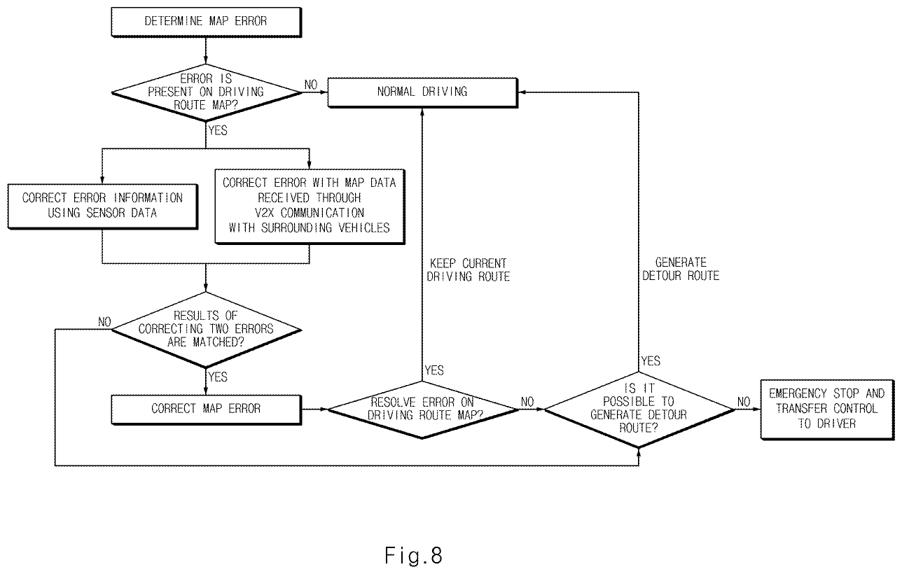

Hereinafter, various embodiments of the present invention will be described in detail with reference to FIG. 1, FIG. 2, FIG. 3, FIG. 4, FIG. 5, FIG. 6, FIG. 7, and FIG. 8.

FIG. 1 is a block diagram of an apparatus of determining an error of a precise map, according to various exemplary embodiments of the present invention.

Referring to FIG. 1, an apparatus of determining an error of a precise map include a reference information obtaining module 100, an error determining module 200, and a map error correcting module 300. The reference information obtaining module 100 may obtain reference information for comparison with a precise map, which guides a route of autonomous driving, in real time during autonomous driving. The error determining module 200 may determine whether there is an error on the precise map, by comparing data on the precise map with the reference information. The map error correcting module 300 may determine whether to correct the data on the precise map, based on the reference information to be corrected.

The reference information obtaining module 100 may include a sensor data receiver 110 that obtains object sensing data recognized by a Light Detection and Ranging (LiDAR) sensor provided in the vehicle as the reference information.

A Light Detection and Ranging (LiDAR) sensor 10 may precisely grasp a surrounding environment by emitting a laser pulse, receiving the light reflected from a target object around a vehicle, and measuring a distance to the target object.

Accordingly, the sensor data receiver 110 may obtain, as the reference information, the object sensing data about the existence and appearance of a surrounding object for comparison with data on the precise map by the data obtained from the LiDAR sensor 10 provided in the vehicle in autonomous driving.

At the present time, in addition to the object sensing data obtained from the LiDAR sensor 10, the sensor data receiver 110 may obtain an image obtained by a camera 20 provided in the vehicle as the reference information together.

Accordingly, it is possible to improve the reliability of the reference information obtained from the reference information obtaining module 100, by obtaining the object sensing data about the existence and appearance of the object recognized by the LiDAR sensor 10 and the image obtained from the camera 20 together as fusion data.

The sensor data receiver 110 may obtain information related to a traffic light, which is provided on a road where a vehicle is autonomously driving, road surface information, and line information as the object sensing data. The traffic light information, the road surface information, and the line information may be object information obtained in autonomous driving through comparison with the precise map.

At the present time, the traffic light information may obtain a location (a relative location of a traffic light recognized by a vehicle in autonomous driving) of the traffic light, the type (whether a traffic light is a horizontal traffic light or a vertical traffic light) of the traffic light, and the number (whether the traffic light has a bi-color, tri-color, or four-color light) of spheres included in the traffic light as the object sensing data.

Furthermore, the road surface information may obtain a location (a relative location of a road surface recognized by a vehicle in autonomous driving) of a road surface, a shape (a marking type displayed on a road surface) of the road, and the type (go straight, go straight-turn left, go straight-turn right, turn left, turn right, no turn right, or the like) of an arrow displayed on the road as the object sensing data.

Moreover, the line information may obtain a location (a relative location recognized by a vehicle in autonomous driving) of a line, a color (white, yellow, blue, white-yellow double lines, or the like) of the line, and the type (a solid line, a dotted line, a double line, a zig-zag line, or the like) of the line as the object sensing data.

Also, the reference information obtaining module 100 may further include a vehicle-to-everything (V2X) data receiver 120 that obtains comparison map data received from one or more other vehicles around a vehicle as the reference information by a V2X module 30 for data communication with a surrounding vehicle.

The V2X data receiver 120 may obtain the comparison map data for the corresponding area, which is the driving base of a vehicle, as the reference information from other vehicles around the vehicle being driven.

Accordingly, when the comparison map data is obtained from another vehicle as the reference information, the format of the precise map, which is the driving base of the vehicle, is the same as the format of the comparison map data received as V2X data for comparison, and thus it is possible to more rapidly and accurately determine whether there is an error in the map, by identifying a difference through one-to-one comparison of the corresponding area.

Also, the error determining module 200 may include a sensing data comparator 210 that determines whether the object sensing data matches data for a corresponding object on the precise map, by comparing the object sensing data with the data for the corresponding object on the precise map and recognizes that there is an error in the precise map, when the object sensing data does not match the data for the corresponding object on the precise map.

Besides, the sensing data comparator 210 may compare traffic light information, road surface information, and line information, which are included in the object sensing data obtained from the sensor data receiver 110, with traffic light information, road surface information, and line information included in the precise map, respectively, and then may determine whether an error is present in data such as whether each object is present, a location of each object, a type of each object, or a shape of each object in the precise map.

At the present time, with regard to the traffic light information, the location and height where a traffic light is provided on a road, an installation type (a horizontal, vertical, or pedestrian traffic light) of a traffic light, the number (whether a traffic light is a bi-color light, a tri-color light or a four-color light) of spheres provided in a traffic light, the height of a traffic light, or the like may be selected as data on the precise map for comparison with the object sensing data.

Accordingly, the sensing data comparator 210 may compare the traffic light information selected from the precise map with traffic light information obtained as the object sensing data, and may determine whether the location and height of a traffic light, the type of a traffic light, and the number of spheres provided in a traffic light are matched. When the traffic light information selected from the precise map is matched with traffic light information obtained as the object sensing data, the sensing data comparator 210 may determine that there is an error in the data on the precise map.

Moreover, with regard to the road surface information, a marking location and marking type (whether a road surface is a crosswalk, a speed bump, an arrow, a number, a letter, a stop line, or a bus stop) of a road surface, a location and type (go straight, go straight-turn left, no turn right, or the like) of an arrow, or the like may be selected as data on the precise map for comparison with the object sensing data.

Accordingly, the sensing data comparator 210 may compare the road surface information selected from the precise map with road surface information obtained as the object sensing data, and then may determine whether a marking location and marking type of a road surface, a location and type of an arrow, and the like are matched. When the road surface information selected from the precise map is matched with road surface information obtained as the object sensing data, the sensing data comparator 210 may determine that there is an error in the data on the precise map.

Also, with regard to line information, a location and color (white, yellow, blue, white-yellow double lines, or the like) of a line and the type (a solid line, a dotted line, a double line, a zig-zag line, or the like) of a line may be selected as data on the precise map to compare with the object sensing data.

Accordingly, the sensing data comparator 210 may compare the line information selected from the precise map with line information obtained as the object sensing data, and then may determine whether a location and color of a line, a type of line, and the like are matched. When the line information selected from the precise map is matched with line information obtained as the object sensing data, the sensing data comparator 210 may determine that there is an error in the data on the precise map.

Furthermore, the error determining module 200 may further include a V2X data comparator 220 that determines whether the comparison map data matches the data on the precise map, by comparing the comparison map data received from another vehicle by the V2X data receiver with the data on the precise map and recognizes that an error is present in the data on the precise map, when the comparison map data does not match the data on the precise map.

At the present time, the V2X data comparator 220 may compare the two map data having the same format as each other one-to-one and then may determine whether there is an error in the data on the precise map, making a quick determination with high accuracy.

Besides, the error determining module 200 may further include a comparison target specifying device 230. The comparison target specifying device 230 may determine an area on a map which is a comparison target, based on the total amount of data on the precise map and comparison map data to be compared to determine whether there is an error in the precise map.

The error determining module 200 may determine, in real time, whether there is an error in the data on the precise map, to prevent accidents caused by errors existing in the precise map in a vehicle which is autonomously driving based on the precise map.

For the present reason, the sensing data comparator 210 may compare object sensing data for a specific object (e.g., traffic light information, road surface information, line information, or the like) obtained through the sensor data receiver 110 with data for each object on the precise map, and thus data throughput may not increase significantly.

On the other hand, because the V2X data comparator 220 receives comparison map data itself for the corresponding area from a surrounding vehicle, it may take a lot of time to process all the received data when the amount of received data is large. Accordingly, it may not be suitable to reflect the received data to the correction of a driving route of a vehicle being autonomously driven, in real-time.

Accordingly, when the total amount of the data on the precise map to be compared and the comparison map data received from the V2X data receiver does not exceed an amount of a specific reference configured for being processed in real time, the comparison target specifying device 230 may determine the entire received comparison map data as a comparison target, and then may determine whether there is an error in the precise map through comparison with the data on the precise map.

Furthermore, when the total amount of the data on the precise map to be compared and the comparison map data received from the V2X data receiver exceeds an amount of a specific reference configured for being processed in real time, the comparison target specifying device 230 may determine that only the area overlapping a driving route of a vehicle being autonomously driven is a comparison target, and may determine whether there is an error in the precise map, by comparing only the comparison map data for the area overlapping the vehicle's driving route with the data on the precise map for the corresponding area.

As illustrated in FIG. 6, the comparison target specifying device 230 may exclude a non-driving area (e.g., an area where a vehicle has already passed, or an area that has little relevance to the vehicle's driving because the area does not belong to the driving route) (indicated by a rectangle in FIG. 6) with low relevance to the location and driving route (indicated by a thick dotted line in FIG. 6) of a vehicle being autonomously driven and may determine only the driving area (an area extending in a longitudinal direction along a thick dotted line in FIG. 6) to be located on the vehicle's subsequent driving route as a comparison target. Accordingly, the comparison target specifying device 230 may not compare the data for the non-driving area.

Accordingly, the comparison target specifying device 230 may focus on only the comparative analysis of data for the driving area by excluding comparative analysis of data for the non-driving area, and thus real-time determination may be made by reducing data throughput and processing time required for the comparative analysis of data.

Besides, the map error correcting module 300 may include a precise map correcting device 320 that corrects the data on the precise map based on the reference information obtained from the reference information obtaining module, when it is determined, by the error determining module 200, that there is an error on the precise map.

To the end, the precise map correcting device 320 may replace data on the precise map, which is determined to have an error, with object sensing data or comparison map data obtained from the reference information obtaining module 100 to be corrected and stored.

Accordingly, it may be applied to the correction of a current driving route in autonomous driving by correcting and storing the precise map in a state where the replaced object information or map information is correctly reflected. Afterward, autonomous driving based on the correct precise map in the same area is possible, improving driving safety.

Furthermore, the map error correcting module 300 may further include a correction determining device 310 that determines whether a correction criterion for data correction is satisfied, to determine whether the object sensing data and comparison map data, which are obtained from the reference information obtaining module, are reliable enough to replace the data on the precise map.

In other words, the object sensing data obtained from the reference information obtaining module 100 is based on the sensing value of the LiDAR sensor 10 provided in a vehicle being autonomously driven, and thus the possibility of a sensing error may not be excluded. Also, even in the case of comparison map data obtained from another vehicle through the V2X module 30, the possibility that an error is present in the map information provided by other vehicles may not be excluded.

Accordingly, when the object sensing data or comparison map data obtained from either the LiDAR sensor 10 or the V2X module 30 is different from the data on the precise map, the correction determining device 310 may first determine that there is an error in the precise map. However, the correction determining device 310 may require additional data for increasing the reliability of the obtained data to replace the data on the precise map.

To the end, only when it is determined that there is an error because the data on the precise map is different from fusion data consisting of the object sensing data obtained from the LiDAR sensor 10 and data obtained from an image obtained from the camera 20, the correction determining device 310 may be configured to correct and replace the data on the precise map with the fusion data.

In other words, when it is determined that there is an error because the object sensing data obtained from the LiDAR sensor 10 provided in a vehicle during autonomous driving is different from the data on the precise map, it may be recognized that there is an error, but may not secure the reliability for replacement. Accordingly, the data on the precise map may be maintained as previous data.

Also, only when it is determined that there is an error because the comparison map data, which is obtained while the V2X module 30 performs V2X communication with two or more vehicles around a vehicle being autonomously driven, is completely different from the data on the precise map, the correction determining device 310 may be configured to correct and replace the data on the precise map with the corresponding comparison map data.

In other words, when it is determined that there is an error because the comparison map data obtained by V2X communication from one vehicle around a vehicle during autonomous driving is different from the data on the precise map, it may be recognized that there is an error, but may not secure the reliability for replacement. Accordingly, the data on the precise map may be maintained as previous data.

Moreover, only when a result of correcting the data on the precise map based on the object sensing data obtained from the sensor data receiver 110 matches a result of correcting the error of the data on the precise map based on the comparison map data obtained from the V2X data receiver 120, the correction determining device 310 may be configured to correct and replace the data on the precise map.

Moreover, according to various exemplary embodiments of the present invention, the apparatus of determining an error of a precise map further include a driving route control module 400 that corrects driving control information for autonomous driving when a result of the determination in the error determining module 200 indicates that there is an error in the precise map, and a corresponding error portion is on a driving route of the vehicle for the autonomous driving.

That is, the driving route control module 400 may change driving control information of the vehicle including whether the vehicle driving in an error area is accelerated or decelerated and whether a lane is changed, depending on content, in which an error is corrected, when the error area on the precise map is on a driving route of the vehicle.

As shown in FIG. 2, it appears that there is no traffic light information on a driving route in a precise map. However, when it is determined that there is a traffic light on the driving route in the object sensing data (preferably, fusion data recognized by a Light Detection and Ranging (LiDAR) sensor and a camera) obtained by the reference information obtaining module 100, the driving route control module 400 may recognize the difference as a map error, may add traffic light information to the precise map, and may change driving control information to stop or pass a stop line depending on a color displayed on the traffic light.

Moreover, as shown in FIG. 3, it appears that there is a speed bump in the front on the precise map. However, when it is determined that there is no speed bump in the front on the object sensing data (preferably fusion data recognized by a Light Detection and Ranging (LiDAR) sensor and a camera) obtained by the reference information obtaining module 100, the driving route control module 400 may recognize the difference as a map error, may remove the speed bump from the precise map, and may change driving control information to maintain constant speed driving without deceleration at the location of the removed speed bump.

It is exemplified in FIG. 2 and FIG. 3 as driving control information is changed based on the object sensing data. However, it is obvious that driving control information is changed to be applied to current autonomous driving control through comparison with comparison map data received from the V2X data receiver 120.

At the present time, as shown in FIG. 4, although it is determined that an error is present on the precise map, when an area on the precise map which is determined to have an error is an area irrelevant to a driving route while a vehicle is autonomously driving, it is obvious that the driving route control module 400 may maintain an autonomous driving state without changing driving control information.

In FIG. 4, a driving route of a vehicle being autonomously driven is indicated with a thick dotted line, and an area on the precise map which is determined to have an error is indicated with a rectangular box. Accordingly, even when an error is present on the precise map, the driving route control module 400 determines that the error does not affect a driving route, and maintains driving control information for controlling a current autonomous driving state.

Besides, as illustrated in FIG. 5, the driving route control module 400 may generate a detour route configured for reaching a destination by avoiding the error area at a current location, may correct the generated detour route to a new driving route, and may continue autonomous driving, when it is determined that it is difficult for the vehicle to continue driving on a current driving route due to an error existing on the precise map.

In FIG. 5, a current driving route of a vehicle being autonomously driven is indicated with a thick dotted line, and an area on the precise map which is determined to have an error is indicated with a rectangular box. The driving route control module 400 may recognize that an error area overlaps a driving route, may determine whether there is a new route configured for reaching a destination while avoiding the corresponding error area, may generate a detour route as indicated by an arrow in a form of a solid line in FIG. 5, and may maintain autonomous driving.

Furthermore, when it is determined that the error area on the precise map overlaps with a current driving route and it is not possible to generate a detour route configured for reaching the destination, continuous autonomous driving becomes impossible, and thus the driving route control module 400 may make an emergency stop on a shoulder road and then may transfer control of the vehicle to a driver. Accordingly, it is possible to prevent accidents from occurring due to autonomous driving despite an error of the precise map.

Next, a method of determining an error of a precise map according to various exemplary embodiments of the present invention will be described with reference to FIGS. 7 and 8.

FIG. 7 is a schematic diagram of a method for determining an error of a precise map, according to various exemplary embodiments of the present invention. FIG. 8 is a flowchart illustrating a flow of verifying an error of a precise map and determining whether a driving route is bypassed, according to various exemplary embodiments of the present invention.

Referring to FIG. 7, according to various exemplary embodiments of the present invention, a method for determining an error of a precise map includes a reference information obtaining step S100 of obtaining reference information for comparison with a precise map, which guides a route of autonomous driving, in real time during autonomous driving, an error determining step S200 of determining whether there is an error on the precise map, by comparing data on the precise map with the reference information, and a map error correcting step S300 of determining whether to correct the data on the map according to the reference information to be corrected.

Furthermore, the reference information obtaining step S100 may include a sensor data receiving process S110 of obtaining object sensing data associated with the existence, location, and appearance of a surrounding object recognized by a Light Detection and Ranging (LiDAR) sensor provided in a vehicle, as the reference information for comparison with the data on the precise map.

At the present time, in the sensor data receiving step S110, an image obtained by a camera provided in the vehicle as the reference information may be obtained in addition to the object sensing data obtained from the LiDAR sensor.

Accordingly, the reliability of reference information obtained in the sensor data receiving process S110 may be improved by obtaining object sensing data recognized by a Light Detection and Ranging (LiDAR) sensor and an image captured by a camera as fusion data and obtaining reference information for comparison with data on the precise map.

In the sensor data receiving step S110, traffic light information including the existence, location, and type of a traffic light provided on a road on which a vehicle is autonomously driving, road surface information including a location of a road surface, a marking type indicated on the road surface, and the type of an arrow indicated on the road surface, and line information including a location, color, and type of a line may be obtained as the object sensing data.

Also, the reference information obtaining step S100 may further include a V2X data receiving process S120 that obtains comparison map data received from another vehicle around a vehicle as the reference information by a V2X module for data communication with a surrounding vehicle.

In the V2X data receiving process S120, the format of comparison map data obtained from another vehicle is the same as the format of the precise map, which is the driving base of a vehicle, and thus it is possible to identify an error on the precise map through one-to-one comparison of the corresponding area. Accordingly, it is possible to more rapidly and accurately determine whether there is an error on the map.

Also, the error determining step S200 may include a sensing data comparing process S210 that determines whether the object sensing data matches data for a corresponding object on the precise map, by comparing the object sensing data with the data for the corresponding object on the precise map and determines that there is an error on the precise map, when the object sensing data does not match the data for the corresponding object on the precise map.

In the sensing data comparing process S210, with regard to the traffic light information, a location and height of a traffic light, an installation type of a traffic light, the number of spheres provided in a traffic light, a height of a traffic light, or the like may be selected as the data on the precise map for comparison with the object sensing data.

Accordingly, in the sensing data comparing process S210, it is possible to compare the traffic light information selected from the precise map with traffic light information obtained as the object sensing data, and to determine whether the existence of a traffic light, a location of a traffic light, the type of a traffic light, and the number of spheres provided in a traffic light are matched. When the traffic light information selected from the precise map is not matched with traffic light information obtained as the object sensing data, it is possible to determine that there is an error in data on the precise map.

Furthermore, in the sensing data comparing process S210, with regard to road surface information and line information, it is possible to select data on the precise map and to determine whether the selected data is matched with the object sensing data, by comparing the selected data with the object sensing data. When the selected data is not matched with the object sensing data, it may be determined that there is an error in the data on the precise map.

Also, the error determining step S200 may include a V2X data comparing process S220 that determines whether the comparison map data matches the data on the precise map, by comparing the comparison map data with the data on the precise map, and then determines that there is an error in the precise map, when the comparison map data does not match the data on the precise map.

At the present time, the error determining step S200 may further include a comparison target specifying process S230 that determines an area on a map which is a comparison target, based on the total amount of data on the precise map and comparison map data to be compared to determine whether there is an error in the precise map.

In the comparison target specifying process S230, it is possible to determine the entire received comparison map data as a comparison target, when the total amount of the data on the precise map to be compared and the comparison map data does not exceed an amount of a specific reference configured for being processed in real time.

Furthermore, in the comparison target specifying process S230, it is possible to determine only an area overlapping a driving route of the vehicle being autonomously driven as a comparison target, when the total amount of the data on the precise map to be compared and the comparison map data exceeds the amount of a specific reference configured for being processed in real time.

Accordingly, autonomous driving may be controlled depending on real-time error determination and the determination result, by not excessively increasing the total amount of comparison map data and precise map data that are to be processed for error determination.

Besides, the map error correcting step S300 may include a precise map correcting process S320 that corrects the data on the precise map based on the reference information obtained from the reference information obtaining step S100, when it is determined, in the error determining process S200, that there is an error on the precise map.

In the precise map correction process S320, data on the precise map determined to have an error may be replaced with the object sensing data obtained in the sensor data receiving process S110 or the comparison map data obtained in the V2X data receiving process S120 to be corrected and stored.

Furthermore, the map error correcting step S300 may further include a correction determining process S310 that determines whether a correction criterion for data correction is satisfied, to determine whether the object sensing data and the comparison map data are reliable to replace the data on the precise map, before the precise map correcting process S320.

In the correction determining process S310, the data on the precise map may be corrected and replaced with the fusion data only when it is determined that there is an error because the data on the precise map is different from the fusion data including the object sensing data obtained from a Light Detection and Ranging (LiDAR) sensor and data obtained from an image obtained from a camera. Accordingly, when the image is not obtained from the camera and the object sensing data is obtained only from the LiDAR sensor, it is possible to recognize that there is an error, but it is determined that reliability for data replacement on the precise map is not secured. Accordingly, the data on the precise map may be set to be maintained as the previous data.

Also, in the correction determining process S310, it is possible to correct and replace the data on the precise map with the corresponding comparison map data, only when it is determined that there is an error because the comparison map data, which is obtained during V2X communication with two or more vehicles around a vehicle being autonomously driven, is completely different from the data on the precise map. Accordingly, when the comparison map data obtained through V2X communication from one vehicle is different from the data on the precise map, it is possible to recognize that there is an error, but the data on the precise map may be set to be maintained as the previous data.

As illustrated in FIG. 8, in the correction determining process S310, the data on the precise map may be set to be corrected and replaced, only when a result of correcting an error of the data on the precise map based on the object sensing data matches a result of correcting an error of the data on the precise map based on the comparison map data.

Also, according to various exemplary embodiments of the present invention, the method for determining an error of a precise map further includes a driving route controlling step S400 that corrects driving control information for autonomous driving when a result of the determination in the error determining process S200 indicates that there is an error in the precise map, and a corresponding error portion is on a driving route of the vehicle for the autonomous driving.

Furthermore, in the driving route controlling step S400, when the error area on the precise map is on a driving route, driving control information of a vehicle including whether the vehicle being autonomously driven in an error area is accelerated or decelerated and whether a lane is changed may be changed depending on content, in which an error is corrected. That is, in the driving route controlling step S400, the driving control information of a vehicle being autonomously driven may be controlled to be driven based on the object sensing data or the comparison target data.

At the present time, in the driving route controlling step S400, when an area on the precise map determined to have an error is an area irrelevant to a driving route of a vehicle during autonomous driving, the error may not affect a current driving of the vehicle, and thus an autonomous driving state may be maintained without changing the driving control information.

Besides, in the driving route controlling step S400, when it is determined that it is difficult for the vehicle to continue driving on a current driving route due to an error existing on the precise map, it is possible to generate a detour route configured for reaching a destination by avoiding the error area at a current location, to correct the generated detour route to a new driving route, and to control autonomous driving to be maintained.

Also, in the driving route controlling step S400, although an error area on the precise map overlaps with a current driving route, when it is determined that it is not possible to generate a detour route configured for reaching a destination, continuous autonomous driving becomes impossible. Accordingly, it is possible to make an emergency stop on a shoulder road and then to transfer control of a vehicle to a driver. Accordingly, it is possible to prevent the occurrence of accidents caused due to autonomous driving despite an error on a precise map.

Hereinabove, although the present invention has been described with reference to exemplary embodiments and the accompanying drawings, the present invention is not limited thereto, but may be variously modified and altered by those skilled in the art to which various exemplary embodiments of the present invention pertains without departing from the spirit and scope of the present invention claimed in the following claims.

Therefore, embodiments of the present invention are not intended to limit the technical spirit of the present invention, but provided only for the illustrative purpose. The scope of protection of the present invention should be construed by the attached claims, and all equivalents thereof should be construed as being included within the scope of the present invention.

The present invention may directly determine whether an error is present in a precise map, which is the basis of autonomous driving, based on object sensing data obtained by a Light Detection and Ranging (LiDAR) sensor or comparison map data obtained by a V2X module in a vehicle in autonomous driving, and may correct data on the precise map depending on the determination result. Therefore, the reliability of the precise map may be improved.

Furthermore, the present invention may correct driving control information of a vehicle for autonomous driving in real time based on data on the corrected precise map when an error area determined to have an error is present on a driving route for autonomous driving, by use of reference information obtained by the LiDAR sensor or the V2X module. Therefore, autonomous driving may be made stably.

Moreover, when it is determined that it is difficult for a vehicle to continue driving on a current driving route due to an error existing on the precise map, the present invention may generate and present a detour route configured for reaching a destination by avoiding the error area in the current location, continuous autonomous driving.

Besides, a variety of effects directly or indirectly understood through the specification may be provided.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

In various exemplary embodiments of the present invention, each operation described above may be performed by a control device, and the control device may be configured by multiple control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An apparatus of determining an error of a map, the apparatus comprising:
a reference information obtaining module configured to obtain reference information for comparison with the map, which guides a route of autonomous driving, in real time during the autonomous driving;
an error determining module configured to determine whether there is an error on the map, by comparing data on the map with the reference information; and
a map error correcting module configured to determine whether to correct the data on the map according to the reference information to be corrected.

2. The apparatus of claim 1, wherein the reference information obtaining module includes:
a sensor data receiver configured to obtain object sensing data for a surrounding object for comparison with the data on the map by a Light Detection and Ranging (LiDAR) sensor provided in a vehicle being autonomously driven, as the reference information.

3. The apparatus of claim 2, wherein the sensor data receiver is configured to obtain an image obtained by a camera provided in the vehicle as the reference information in addition to the object sensing data obtained from the LiDAR sensor.

4. The apparatus of claim 1, wherein the reference information obtaining module further includes:
a vehicle to everything (V2X) data receiver configured to obtain comparison map data received from one or more other vehicles by a V2X module for data communication with a surrounding vehicle, as the reference information.

5. The apparatus of claim 2, wherein the error determining module includes:
a sensing data comparator configured to:
determine whether the reference information matches data for a corresponding object on the map, by comparing the reference information with the data for the corresponding object on the map; and
recognize that there is an error in the map, when the reference information does not match the data for the corresponding object on the map.

6. The apparatus of claim 5, wherein the sensing data comparator configured to:
compare traffic light information, road surface information, and line information, which are included in the object sensing data obtained from the sensor data receiver, with traffic light information, road surface information, and line information included in the map, respectively; and
determine whether an error is present in at least one data about whether each object is present, a location of each object, a type of each object, or a shape of each object in the map.

7. The apparatus of claim 4, wherein the error determining module further includes a V2X data comparator configured to:
determine whether the comparison map data matches the data on the map, by comparing the comparison map data received from another vehicle by the V2X data receiver with the data on the map; and
recognize that the error is present in the data on the map, when the comparison map data does not match the data on the map.

8. The apparatus of claim 7, wherein the error determining module further includes a comparison target specifying device configured to:
determine whether there is the error in the map, by determining only an area overlapping a driving route of the vehicle being autonomously driven as a comparison target when a total amount of the data on the map to be compared and the comparison map data received from the V2X data receiver exceeds an amount of a predetermined reference configured for being processed in real time.

9. The apparatus of claim 2, wherein the map error correcting module includes a precise map correcting device configured to:
correct the data on the map according to the reference information obtained from the reference information obtaining module when the error determining module determines that there is the error on the map.

10. The apparatus of claim 9, wherein the map error correcting module further includes a correction determining device configured to:
determine whether a correction criterion for data correction is satisfied, to determine whether the object sensing data and comparison map data, which are obtained from the reference information obtaining module, are reliable to replace the data on the map.

11. The apparatus of claim 2, further including a driving route control module configured to:
correct driving control information for the autonomous driving when a result of the determination in the error determining module indicates that there is the error in the map, and a corresponding error portion is on a driving route of the vehicle for the autonomous driving.

12. The apparatus of claim 11, wherein the driving route control module is configured to change driving control information of the vehicle including whether the vehicle driving in an error area is accelerated or decelerated and whether a lane is changed, depending on content, in which an error is corrected, when the error area on the map is on a driving route of the vehicle.

13. The apparatus of claim 11, wherein the driving route control module is configured to:
when it is determined that it is difficult for the vehicle to continue driving on a current driving route due to the error existing on the map, generate a detour route configured for reaching a destination by avoiding the error area at a current location of the vehicle;
correct the generated detour route to a new driving route; and
continue the autonomous driving according to the new driving route.

14. The apparatus of claim 11, wherein the driving route control module is configured to stop the vehicle and to allow control of the vehicle to be transferred to a driver, when it is determined that an error area on the map overlaps with a current driving route of the vehicle, and that it is not possible to generate a detour route configured for reaching the destination.

15. A method for determining an error of a map, the method comprising:
obtaining reference information for comparison with the map, which guides a route of autonomous driving, in real time during the autonomous driving;
determining whether there is the error on the map, by comparing data on the map with the reference information; and
determining whether to correct the data on the map according to the reference information to be corrected.

16. The method of claim 15, wherein the obtaining of the reference information includes:
obtaining object sensing data associated with existence, a location, and an appearance of a surrounding object recognized by a Light Detection and Ranging (LiDAR) sensor provided in a vehicle, as the reference information for comparison with the data on the map.

17. The method of claim 15, further including:
correcting driving control information for the autonomous driving when a result of the determination in the determining of whether there is the error on the map indicates that there is the error in the map, and a corresponding error portion is on a driving route of the vehicle for the autonomous driving.

18. The method of claim 17, wherein the correcting of the driving control information includes:
changing driving control information of the vehicle including whether the vehicle autonomously driving in an error area is accelerated or decelerated and whether a lane is changed, depending on content, in which an error is corrected, when the error area on the map is on a driving route of a vehicle.

19. The method of claim 17, wherein the correcting of the driving control information includes:
when it is determined that it is difficult for a vehicle to continue driving on a current driving route due to the error existing on the map, generating a detour route configured for reaching a destination by avoiding the error area at a current location of the vehicle;
correcting the generated detour route to a new driving route; and
controlling autonomous driving to be maintained.

20. The method of claim 17, wherein the correcting of the driving control information includes:
stopping a vehicle and allowing control of the vehicle to be transferred to a driver, when it is determined that it is not possible to generate a detour route configured for reaching a destination although an error area on the map overlaps with a current driving route of the vehicle.
